(19) United States
(12) Patent Application Publication
(10) Pub. No.: US 2017/0243691 A1
(43) Pub. Date: Aug. 24, 2017

(54) COIL ASSEMBLY FOR INDUCTIVE ENERGY TRANSMISSION, INDUCTIVE ENERGY-TRANSMISSION DEVICE, AND METHOD FOR MANUFACTURING A COIL ASSEMBLY FOR INDUCTIVE ENERGY TRANSMISSION

(71) Applicant: Robert Bosch GmbH, Stuttgart (DE)

(72) Inventors: Felix Stewing, Steinheim (DE); Tobias Diekhans, Stuttgart-Vaihingen (DE)

(21) Appl. No.: 15/519,267

(22) PCT Filed: Jul. 28, 2015
(86) PCT No.: PCT/EP2015/067275

§ 371 Date: Apr. 14, 2017

(30) Foreign Application Priority Data
Oct. 16, 2014 (DE) 10 2014 220 978.1

(51) Int. Cl. H01F 27/28; H01F 27/40; H02J 7/02; H01F 29/02; H02J 50/10; H01F 38/14; H01F 41/04

(52) U.S. Cl. CPC H01F 27/2804; H01F 38/14; H01F 27/40; H01F 41/041; H01F 29/02; H02J 50/10; H02J 7/025; H01F 2027/2809; B60L 11/182

(57) ABSTRACT

The invention relates to a coil assembly (1) for inductive energy transmission, comprising: an electrically non-conductive substrate (2), which has a first side (10) and a second side (11); a plurality of conducting tracks (30), which are arranged on the first side (10) and on the second side (11) of the substrate (2) and which form a coil (50) for inductive energy transmission; a plurality of vias (4) in the substrate (2) for feeding the conducting tracks (30) through the substrate (2); wherein at least two of the plurality of conducting tracks (30) are arranged in a twisted manner in relation to each other in the substrate (2). The invention further relates to an energy transmission device and to a method for producing a coil assembly (1) for inductive energy transmission.

### BACKGROUND OF THE INVENTION

The invention relates to a coil assembly for inductive energy transmission and to an inductive energy transmission device. The present invention further relates to a method for manufacturing a coil assembly for inductive energy transmission.

Electric vehicles, which are driven solely by means of an electric motor, are known. In addition, plug-in hybrids are also known, which are driven by means of a combination of an electric motor and one further drive machine. In this case, the electric energy for driving the electric motor is provided by an electrical energy accumulator, for example, a traction battery. After the energy accumulator has been completely or partially discharged, the energy accumulator must be recharged. There are various approaches for charging the energy accumulator.

On the one hand, it is possible to galvanically connect the electric vehicle to a charging station by means of a suitable charging cable. For this purpose, the user must establish an electrical connection between the electric vehicle and the charging station. This can be perceived as being unpleasant, in particular during adverse weather conditions, such as rain, for example. Due to the very limited electrical range of electric and plug-in hybrid vehicles, this cable connection must also be established very often by the user, which is perceived by many users as a great disadvantage of electric vehicles as compared to conventional vehicles.

Therefore, on the other hand, there are also wireless solutions for transmitting energy from a charging station to an electric vehicle. In this case, the energy is inductively transmitted from the charging station via a magnetic alternating field from a primary coil to a secondary coil in the electric vehicle and is fed to the traction battery in the vehicle.

In order to form the primary coil, a high frequency stranded wire (also referred to as an HF stranded wire), among other things, is used, which consists of a relatively large number of fine wires which are insulated from one another and are interwoven in such a way that every single wire, in the statistical mean, assumes preferably every point in the total cross-section of the stranded wire equally often.

DE 10 2013 010 695 A1 describes a primary winding assembly which comprises a winding assembly and a winding wire. In one advantageous embodiment, an HF stranded wire is used as the winding wire, wherein the stranded wire is designed as a bundle of individual wires which are electrically insulated from one another.

### SUMMARY OF THE INVENTION

The invention provides a coil assembly for inductive energy transmission, and an inductive energy transmission device, and a method for manufacturing a coil assembly.

Thus, the following is provided:

A coil assembly for inductive energy transmission, comprising an electrically non-conductive substrate which has a first side and a second side; a plurality of strip conductors which are disposed on the first side and on the second side of the substrate, and which form a coil for inductive energy transmission; a plurality of vias in the substrate for routing the strip conductors through the substrate; wherein at least two of the plurality of strip conductors are disposed in a twisted manner in relation to each other in the substrate.

Furthermore, an inductive energy transmission device comprising at least one coil assembly according to the invention is provided.

In addition, a method is provided for manufacturing a coil assembly for inductive energy transmission, which includes the following method steps of: providing an electrically non-conductive substrate which has a first side and a second side; forming a plurality of strip conductors on the first side and on the second side of the substrate for forming a coil for inductive energy transmission, wherein at least two of the plurality of strip conductors are disposed in a twisted manner in relation to each other in the substrate.

The idea underlying the present invention is that of using, instead of a wound HF stranded wire, a substrate comprising strip conductors, which are formed thereon and are twisted in relation to each other, as the coil for inductive energy transmission.

Due to the use of a substrate for implementing the stranded wire, several advantages can be simultaneously achieved and more functions can be covered than simply generating the magnetic alternating field. In addition, the simple possibility of partial reactive power compensation of individual windings is achieved, whereby the maximum resonance voltage that occurs can be limited.

A further advantage of the coil assembly presented here is the very simple production using known technologies. For example, the coil assembly can be produced, e.g., as a multilayer circuit board (PCB) or, e.g. as an LTCC circuit board (ceramic). In this case, e.g., substrate segments are simply produced using conventional technology, the components are installed thereon, and the segments are then assembled or, e.g., in the case of smaller coil systems, the entire coil system is produced on a single substrate.

Due to the formation of an HF stranded wire from twisted strip conductors on a substrate, the electromagnetic properties of the coil can be highly exactly adjusted and even precalculated, e.g., it is now possible, by way of twisting with a low filling factor, to reduce the mutual influence of the individual wires and individual windings as compared to a conventional stranded wire.

In this context, “twisted” means that at least two strip conductors extend alternately through the vias from the first side of the substrate to the second side of the substrate and back to the first side of the substrate. In this way, the strip conductors are twisted in relation to each other and are helically wound around one another.

The coil for inductive energy transmission, which is formed by the strip conductors, can be disposed on the substrate in different ways. For example, the coil formed from the strip conductors can be a duolateral coil, a basket coil, a honeycomb coil, or a coil wound in a different way. In this way, the coil can be well adapted to the particular requirements.

The strip conductors swap their positions with one another along their entire course and/or at certain points. The lay ratio is between 1.001 and 2.0, in particular between 1.02 and 1.04 in this case.

The twisting is not limited to only two strip conductors, of course, but rather it is possible for any number of strip conductors to extend so as to be twisted in relation to each other. For example, three strip conductors, four strip conductors, five strip conductors, ten strip conductors, or all strip conductors can be twisted in relation to each other.

Although the subdivision into individual strip conductors results in a lower filling factor overall, a low filling factor can be used for minimizing, e.g., proximity and/or skin effects, by way of an artful magnetic design. According to one preferred refinement, the substrate is formed from multiple substrate segments. For example, the substrate can be formed from multiple substrate segments which have been produced using known technologies, and can be subsequently assembled. In this way, the coil assembly can be adapted to the particular field of application in a very simple way. Furthermore, costs can be reduced as a result of this design, since existing production systems can be used for producing the coil assembly.

According to one further preferred refinement, the substrate segments are designed to be symmetrical with respect to shape. Due to this design of the coil assembly, costs can be further reduced, since the formation of substrate segments which are symmetrical with respect to shape has advantages with respect to production engineering, in particular in large quantities.

According to yet another preferred refinement, the substrate is formed from multiple circular ring segment-shaped substrate segments. For example, the substrate is formed from 2, 3, 4, 5, 6, 7, 8 or more individual substrate segments. The substrate segments can then be assembled to form a circle, or another shape, e.g., a quadrangle, and thereby form a single substrate. Due to this design, the production costs and the overall manufacturing costs can be reduced, since the production of identically designed substrate segments can take place in an automated manner and in large quantities.

According to yet another preferred refinement, the substrate or a substrate segment comprises a strip conductor section which is designed for the variable interconnection of the strip conductors. For example, one substrate segment comprises a strip conductor section which electrically couples two, three or more strip conductors or strip conductor sections to one another. Due to this design, the number of windings and/or the winding cross-section of the coil can be adapted to the particular application in an easy way without the need to change all the substrate segments or the entire substrate.

According to yet another preferred refinement, the strip conductor section comprises active switches for adjusting the number of windings and/or the winding cross-section, in order to allow for a variable interconnection. The switches can be designed, for example, as semiconductor switches or relays, and can be controllable via a control device. In this way, the number of windings and/or the winding cross-section of the coil can be adjusted during the operation of the coil.

According to one preferred refinement, capacitors are disposed between adjacent substrate segments for interconnecting the strip conductors of the substrate segments. For example, ceramic capacitors are used for interconnecting the individual substrate segments. Ceramic capacitors can be produced in the desired shape in an easy way due to the easy moldability of the ceramic base. Furthermore, ceramic capacitors are virtually non-flammable. Furthermore, ceramic capacitors can be manufactured in the form of SMD multilayer ceramic chip capacitors (MLCC) in a technically favorable and cost-favorable way as surface-mountable components. The capacitors can also be designed, e.g., as plastic-film capacitors, however.

According to yet another preferred embodiment, the substrate comprises multiple substrate layers, wherein the strip conductors are formed on both sides of the individual substrate layers. Due to the design of the substrate having multiple substrate layers, a multilayer circuit board can be formed, which has a larger number of strip conductors and, therefore, coil windings and/or winding cross-section. For example, a substrate comprises 3, 4, 5, 6, 7, 8, 9, 10, 11, 12 or any number of substrate layers. In this way, the coil assembly can be adjusted to the particular field of application in an easy way.

According to yet another preferred refinement, capacitors are disposed on the substrate, which are designed for the reactive power compensation of the coil. Due to the formation of the coil on a substrate, multiple capacitors can be used, since sufficient space is available with this design. Furthermore, due to this formation, the waste heat from the capacitors can be dissipated via the substrate in a particularly effective way. In addition, compensation can be implemented in a section-wise manner, whereby the maximum resonance voltages that occur can be reduced, with advantages with respect to electromagnetic compatibility and insulation requirements.

Preferably, the reactive power compensation is distributed to at least two capacitors which are disposed on two different strip conductors and/or strip conductor sections and/or substrate segments. In this way, it is possible to carry out the reactive power compensation in a section-wise and/or segment-wise manner. Due to a distributed reactive power compensation, advantages result in terms of the electromagnetic compatibility (EMC) and the insulation requirements, since the maximum resonance voltage that occurs can also be reduced in a section-wise manner.

According to yet another preferred refinement, the strip conductors are designed to be tapered in the region of the vias. In this way, a higher packing density of the strip conductors in the substrate can be achieved. Furthermore, the extent of twisting of the individual strip conductors can be increased in this way.

### BRIEF DESCRIPTION OF THE DRAWINGS

Further features and advantages of the present invention are described in the following on the basis of embodiments and with reference to the figures.

In the drawings:

FIG. 1 shows a schematic top view of a coil assembly according to one embodiment of the present invention;

FIG. 2 shows a schematic top view of a coil assembly according to one further embodiment of the present invention;

FIG. 3 shows a schematic sectional view of a coil assembly according to one further embodiment of the present invention;

FIG. 4 shows a schematic sectional view of a coil assembly according to one further embodiment of the present invention;

FIG. 5 shows a schematic sectional view of a coil assembly according to one further embodiment of the present invention;

FIG. 6 shows a schematic sectional view of a coil assembly according to one further embodiment of the present invention;

FIG. 7 shows a schematic top view of a coil assembly according to one further embodiment of the present invention; and

FIG. 8 shows a schematic top view of a section of a coil assembly according to one further embodiment of the present invention;

FIG. 9 shows a schematic top view of a coil assembly according to one further embodiment of the present invention;

FIG. 10 shows a schematic depiction of twisted strip conductors according to one further embodiment of the present invention;

FIG. 11 shows a schematic depiction of twisted strip conductors according to one further embodiment of the present invention;

FIG. 12 shows a schematic depiction of an energy transmission device according to one embodiment of the present invention; and

FIG. 13 shows a schematic flow diagram of a method for manufacturing a coil assembly for inductive energy transmission.

In the figures, identical reference numbers designate elements that are identical or are functionally identical.

### DETAILED DESCRIPTION

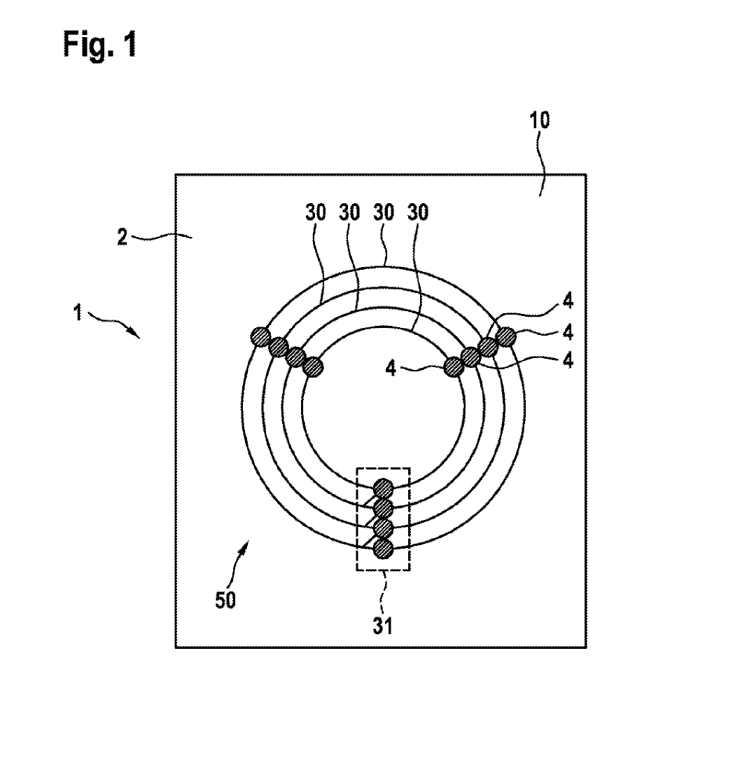

FIG. 1 shows a schematic top view of a coil assembly 1 according to one exemplary embodiment of the present invention. The coil assembly 1 for inductive energy transmission contains an electrically non-conductive substrate 2 which has a first side 10 and a second side 11 (not shown). Disposed on the first side 10 and on the second side 11 of the substrate 2 is a plurality of strip conductors 30 which form a coil 50 for inductive energy transmission. In addition, the coil assembly 1 comprises a plurality of vias 4 which are provided in the substrate 2 for routing the strip conductors 30 through the substrate 2. Of the plurality of strip conductors 30 in the substrate 2, at least two strip conductors 30 are twisted in relation to each other. Furthermore, a strip conductor section 31 is formed on the first side of the substrate 2, which is designed for interconnecting the individual coil windings.

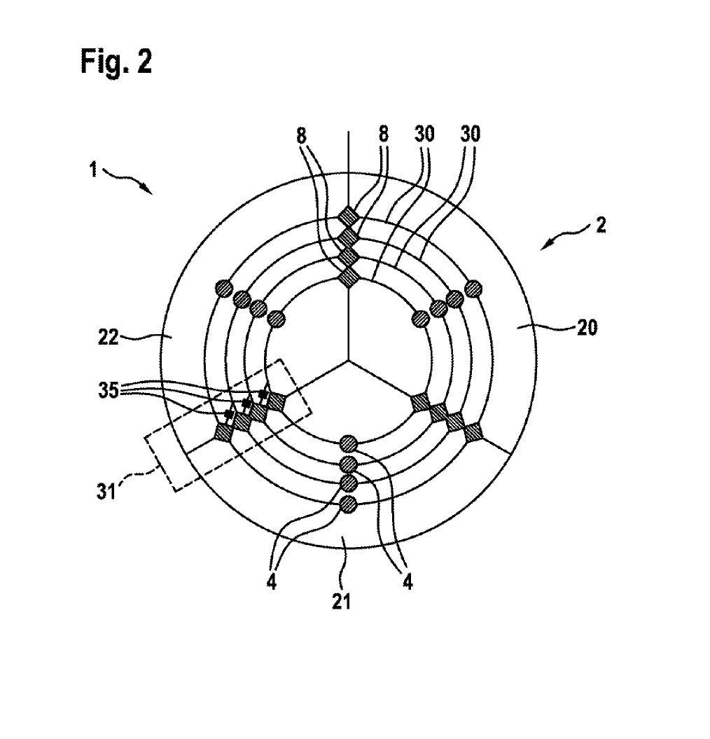

FIG. 2 shows a schematic top view of a coil assembly 1 according to one further embodiment of the present invention. In the embodiment shown, the substrate 2 is formed from three substrate segments 20, 21 and 22. In particular, the individual substrate segments 20, 21 and 22 are designed to be symmetrical with respect to shape, whereby these segments can be manufactured in large quantities in an easy way. In the embodiment shown in FIG. 2, the substrate segments 20, 21 and 22 are designed in the shape of circular segments. The substrate segments 20, 21 and 22 can also be designed in another shape, however. For example, the substrate segments 20, 21 and 22 can also be designed to be square, rectangular, or polygonal. Furthermore, capacitors 8 are disposed between the substrate segments, which are used for the reactive power compensation and for the interconnection of the substrate segments. In addition, a strip conductor section 31 is formed on the substrate segment 22, which is used for interconnecting the individual strip conductors 30. In the embodiment shown, the strip conductor section 31 comprises active switches 35 for adjusting the number of windings and/or the winding cross-section, in order to allow for a variable interconnection. The switches 35 can be designed, for example, as semiconductor switches or relays, and can be controllable via a control device (not shown). In this way, the number of windings and/or the winding cross-section of the coil can be adjusted during the operation of the coil.

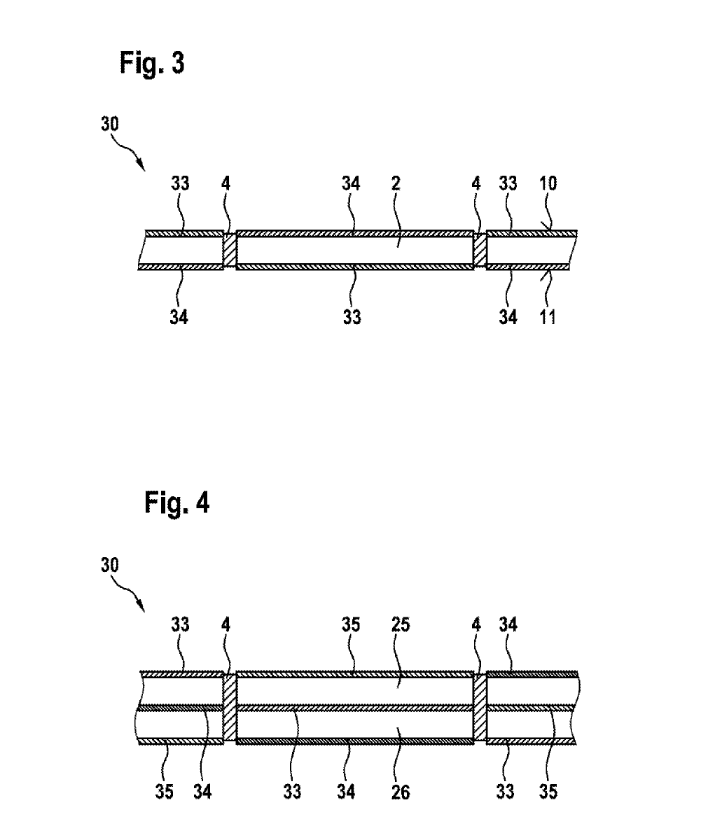

FIG. 3 shows a schematic sectional view of a coil assembly 1 according to one further embodiment of the present invention. The substrate 2 has a first side 10 and a second side 11. Disposed on the first side 10 and on the second side 11 are strip conductors 30 which are formed by the strip conductor sections 33 and 34.

As is apparent, the strip conductor sections 33 and 34 are twisted in relation to each other. This means that the strip conductor sections 33 and 34 extend alternately through the vias 4 from the first side 10 to the second side 11 and back to the first side 10. In this way, the strip conductors 30 are formed so as to be twisted in relation to each other.

FIG. 4 shows a schematic sectional view of a coil assembly 1 according to one further embodiment of the present invention. In this exemplary embodiment, the substrate 2 is formed from two substrate layers 25 and 26. Strip conductor sections 33, 34 and 35 are formed on the substrate layers 25 and 26. The strip conductor sections 33, 34 and 35 are also disposed in the substrate 2 so as to be twisted in relation to each other by means of the vias 4. It is possible, of course, that the coil assembly 1 comprises more than two substrate layers 25 and 25. For example, the coil assembly can also comprise 3, 4, 5, 6 or any number of substrate layers having strip conductors 30 which are twisted in relation to each other.

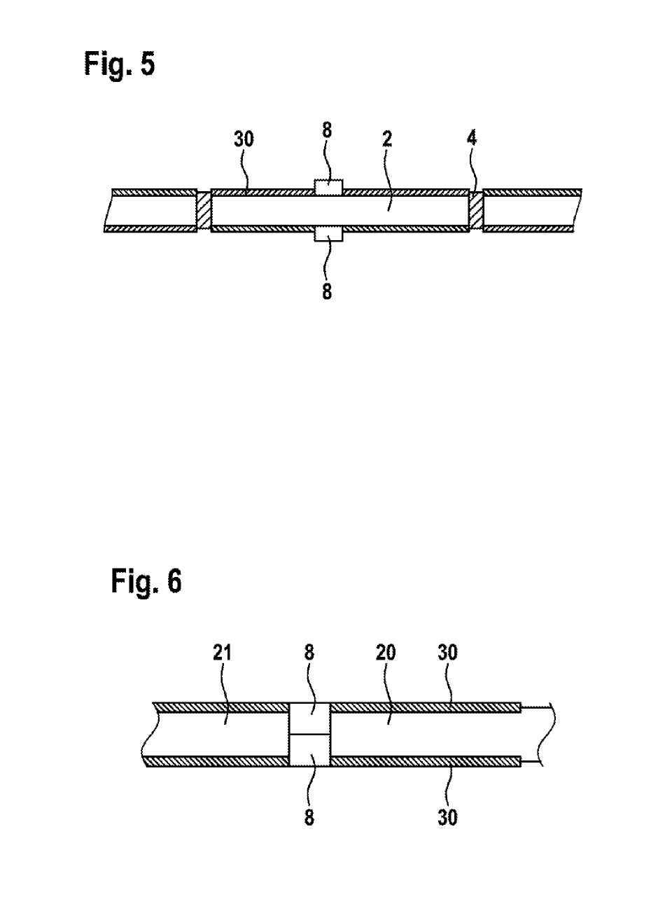

FIG. 5 shows a schematic sectional view of a coil assembly 1 according to one further embodiment of the present invention. In this embodiment, capacitors 8 are disposed on the substrate 2 between the strip conductors 30. For example, the capacitors 8 are provided for the reactive power compensation of the coil 50. Due to the capacitors 8, the coil assembly 1 can be optimally adjusted to the particular field of application and the particular basic conditions in an easy way. Due to the arrangement of the capacitors 8 on the substrate 2, the waste heat from the capacitors 8 can be dissipated particularly effectively via the substrate 2.

FIG. 6 shows a schematic sectional view of a coil assembly 1 according to one further embodiment of the present invention. In this embodiment, the substrate 2 is formed from two substrate segments 20 and 21. Capacitors 8 for interconnecting the strip conductors 30 are provided between the substrate segments 20 and 21. In this way, the capacitors 8 can be used for the reactive power compensation and for the interconnection of the substrate segments 20 and 21.

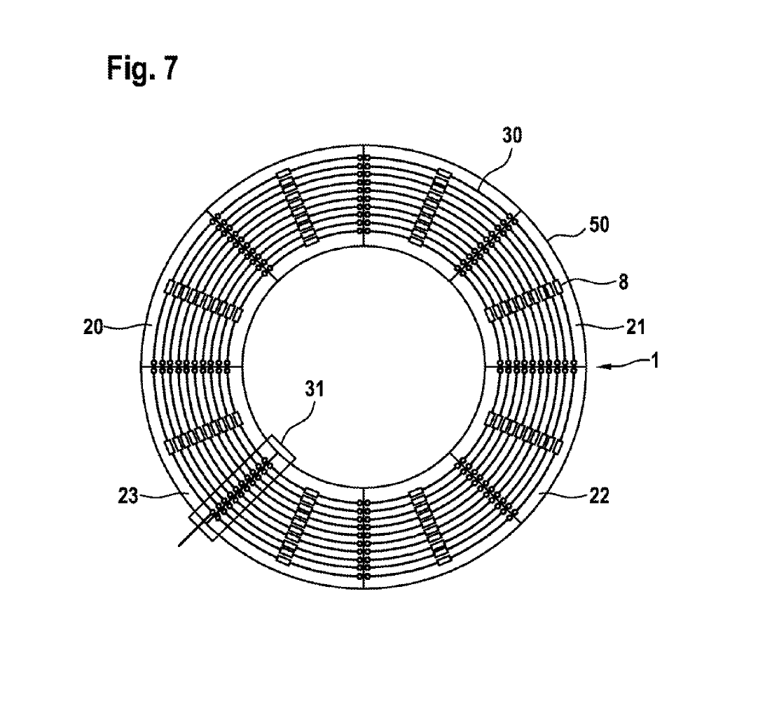

FIG. 7 shows a schematic depiction of one further embodiment of a coil assembly 1. The strip conductors 30 depicted in FIG. 7 consist, in turn, in this embodiment, of multiple strip conductors 30 which have been twisted in a multilayer technique. The advantage results that the quality of the twisting can be highly precisely adjusted and precalculated, which is not possible with a conventional stranded wire. A further advantage is the possibility to implement a “very loose” twisting having an increased distance between the strip conductors 30. Since a high packing density is not required here, the proximity losses can be reduced, since the strip conductors do not closely adjoin one another and they have sufficient distance between one another. A further advantage is the better coolability of the single coil winding, since there is no air in the coil 50, and there is a flat cooling interface to the capacitors 8 and the strip conductors 30. Furthermore, this design makes it possible to dispense with an encapsulation mass which surrounds the coil 50.

Due to the formation of the coil 50 on the substrate 2, it is likewise possible to place practically any number of capacitors 8 which are required for the reactive power compensation during the inductive energy transmission. Due to a design of this type, it is possible to use, e.g., SMC ceramic capacitors for section-wise reactive power compensation instead of the plastic-film capacitors which are common nowadays. Advantages also result with respect to the cooling of the capacitors 8 when the capacitors can be distributed over a larger area. Further advantages result with respect to electromagnetic compatibility (EMC) and insulation requirements due to a distributed reactive power compensation, since the maximum resonance voltage that occurs can be reduced. The coil assembly 1 for inductive energy transmission, which is depicted in FIG. 7, is a series-compensated coil 50. The production technology shown here can also be applied on parallel-compensated coils or any other type of compensation, of course. The coil assembly 1 depicted in FIG. 7 is also formed from multiple circular segment-shaped substrate segments 20, 21, 22 and 23. In addition, a strip conductor section 31 is formed on the substrate segment 23, which is used for interconnecting the individual strip conductors 30.

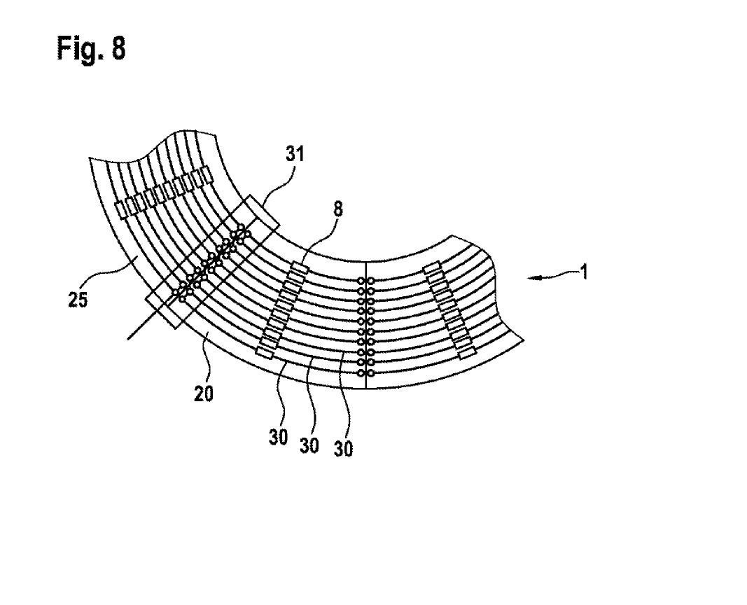

FIG. 8 shows a schematic top view of a section of a coil assembly 1 according to one further embodiment of the present invention. In this exemplary embodiment, the substrate 2 is formed from multiple substrate segments, wherein a substrate segment 25 is depicted in FIG. 8, which comprises a strip conductor section 31 which is formed for the interconnection of the strip conductors 30. By means of the strip conductor section 31, it is possible to implement different numbers of windings and/or strip conductor cross-sections using one and the same substrate 2. In this embodiment, the strip conductor section 31 is designed for electrically connecting two adjacent strip conductors 30 to one another. Due to this design, the inductance of the coil 50 can be adapted to the particular application in a simple way while simultaneously ensuring an optimal current distribution and utilization of all the copper to carry current.

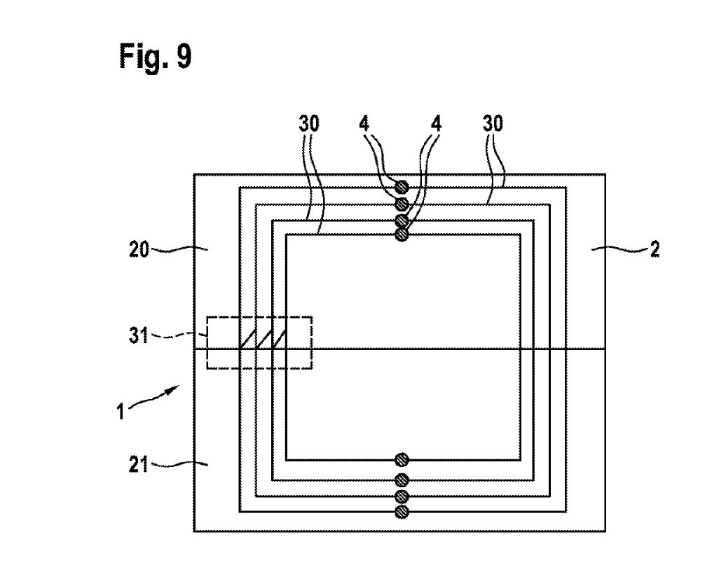

FIG. 9 shows a schematic top view of a coil assembly 1 according to one further embodiment of the present invention. In this embodiment, the substrate 2 is formed from two substrate segments 20 and 21 which have a rectangular shape. In this case, the strip conductors 30 do not extend in the shape of a circle, but rather in the shape of a rectangle. In addition, a strip conductor section 31 is formed on the substrate segment 20, which is used for interconnecting the individual strip conductors 30. The interconnection can take place, e.g., in a simple form, by the placement of the resonance capacitors at this point.

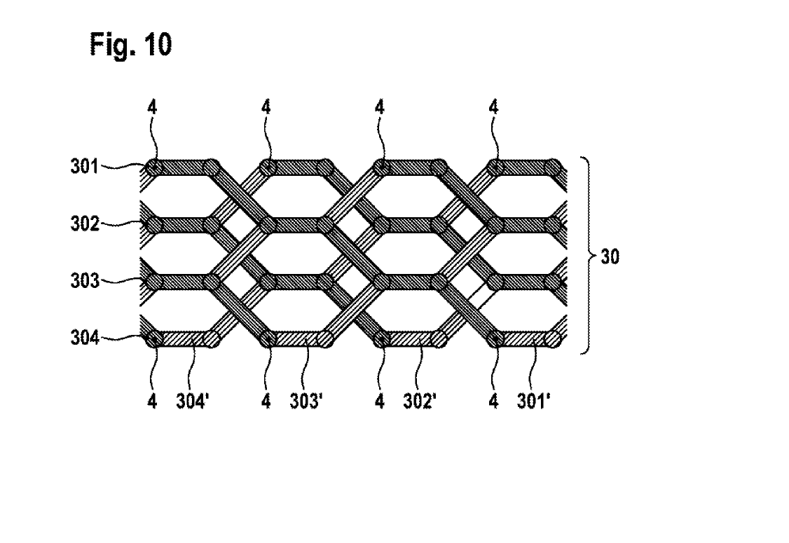

FIG. 10 shows a schematic depiction of twisted strip conductors 30 according to one further embodiment of the present invention. Four strip conductors 301, 302, 303 and 304, which extend on the first side of the substrate, are shown in FIG. 10. Furthermore, strip conductors 301′, 302′, 303′ and 304′ are depicted, which extend on the second side of the substrate. The strip conductors 301, 302, 303 and 304 are electrically connected to the strip conductors 301′, 302′, 303′, and 304′, respectively. The strip conductors 301, 302, 303 and 304 each extend in a stepped manner, falling from left to right, respectively. The strip conductors 301′, 302′, 303′ and 304′ each extend in a stepped manner, rising from left to right. The strip conductors 301, 302, 303 and 304 extend from the first side of the substrate to the second side of the substrate through vias 4. Due to this design, the strip conductors 301, 302, 303, 304, 301′, 302′, 303′ and 304′ are twisted in relation to each other, whereby the losses at higher frequencies, which occur due to the skin effect, can be reduced.

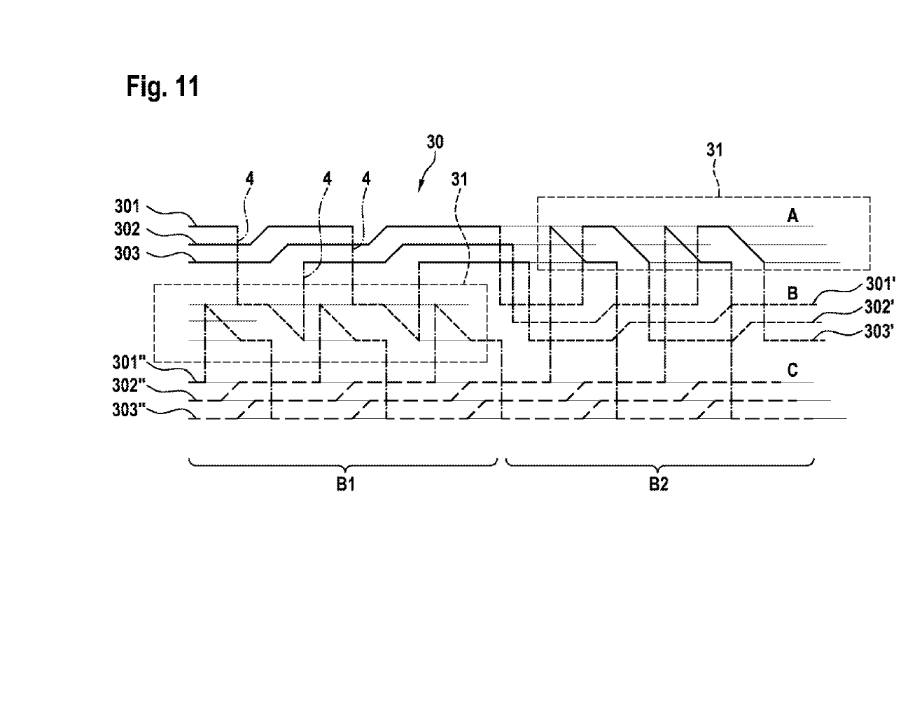

FIG. 11 shows a schematic depiction of twisted strip conductors 30 according to one further embodiment of the present invention. The twisting of strip conductors 30 in three levels A, B, C is shown in this embodiment. For example, the three levels A, B, C are formed in a two-layer substrate. There are three strip conductors 301, 302 and 303 on the left in the first level A. The three strip conductors 301, 302 and 303 are routed to the level B through vias 4, wherein a strip conductor section 31 is formed on the level B, which is used for interconnecting the strip conductors 30. Furthermore, strip conductors 301′, 302′, 303′ are formed on the level B, and strip conductors 301″, 302″, 303″, which are interconnected with strip conductors 301, 302 and 303, are formed on level C. In the region B1, the strip conductors on levels A and C are twisted in relation to each other in the manner of a braid, and the strip conductor section 31, which is used for interconnecting the strip conductors 30, is located on the level B. In the region B2, the strip conductors 30 on levels B and C are twisted in relation to each other in the manner of a braid, wherein a strip conductor section 31, which is used for the interconnection and/or the twisted arrangement of the strip conductors 30, is formed on the level A. The strip conductor section 31 for interconnecting the strip conductors 30 can switch to a different level at regular intervals. This type of twisting can also be carried out using more than three levels, of course.

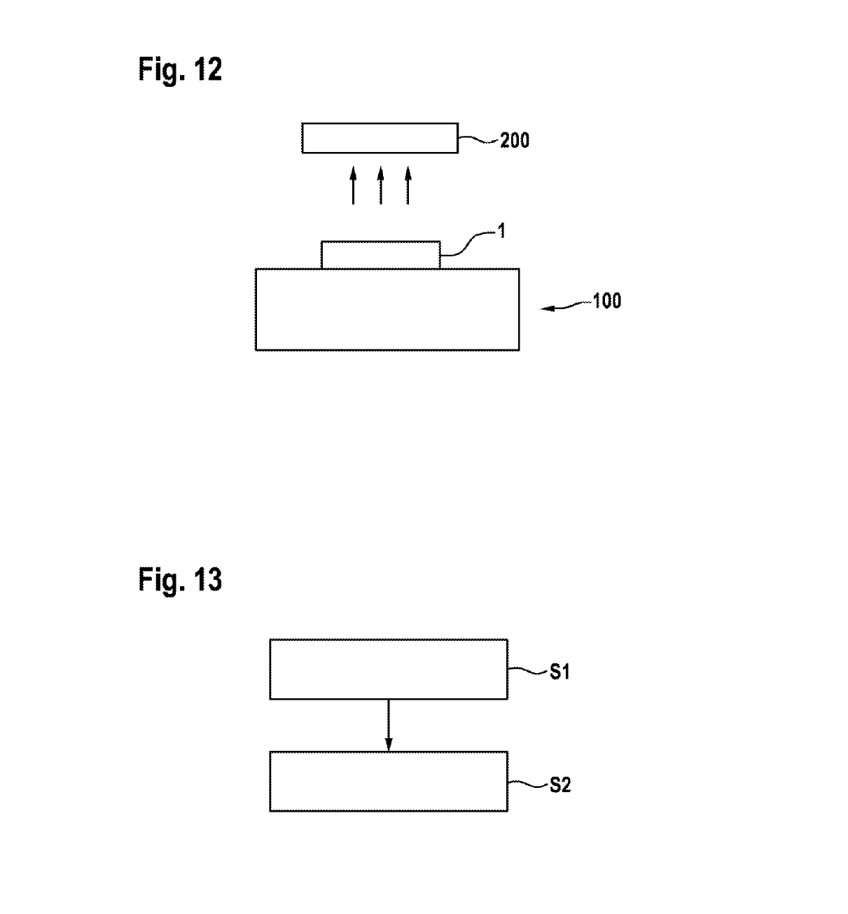

FIG. 12 shows a schematic depiction of an energy transmission device 100 according to one exemplary embodiment of the present invention. The energy transmission device 100 comprises a coil assembly 1 according to the invention. The coil assembly 1 is designed for generating a magnetic alternating field and for inductively transmitting energy to a receiving device 200. The receiving device 200 can be, for example, a traction battery of an electric vehicle.

FIG. 13 shows a schematic flow diagram of a method for manufacturing a coil assembly for inductive energy transmission. In method step Si, an electrically non-conductive substrate is provided, which has a first side and a second side. In method step S2, a plurality of strip conductors is formed on the first side and on the second side of the substrate for forming a coil for inductive energy transmission, wherein at least two of the plurality of strip conductors are disposed in a twisted manner in relation to each other in the substrate. Further method steps can be added upstream, in-between, and/or downstream, in particular for producing multilayer substrates.

The inductive energy transmission and the coil assembly according to the invention can also be used, for example, for contactlessly charging power tools, e-bikes, household devices, and consumer electronics devices.

The type of twisting and the type of winding can also be adapted to the particular field of application and the particular basic conditions.

1. A coil assembly (1) for inductive energy transmission, comprising
an electrically non-conductive substrate (2) which has a first side (10) and a second side (11);
a plurality of strip conductors (30) which are disposed on the first side (10) and on the second side (11) of the substrate (2), and which form a coil (50) for inductive energy transmission; and
a plurality of vias (4) in the substrate (2) for routing the strip conductors (30) through the substrate (2);
wherein at least two of the plurality of strip conductors (30) are disposed in a twisted manner in relation to each other in the substrate (2).

2. The coil assembly (1) as claimed in claim 1, wherein the substrate (2) is formed from multiple substrate segments (20; 21; 22; 24; 25).

3. The coil assembly (1) as claimed in claim 2, wherein the substrate segments are circular segments.

4. The coil assembly (1) as claimed in claim 1, wherein the substrate (2) comprises a strip conductor section (31) which is configured for the variable interconnection of the strip conductors (30).

5. The coil assembly (1) as claimed in claim 4, wherein the strip conductor section (31) comprises active switches (35) for adjusting a number of windings and/or a winding cross-section of the coil (50), in order to allow for a variable interconnection.

6. The coil assembly (1) as claimed in claim 2, wherein capacitors (8) for interconnecting the strip conductors (30) of the substrate segments (20; 21) are disposed between at least two adjacent substrate segments (20; 21).

7. The coil assembly (1) as claimed in claim 1, wherein the substrate (2) comprises multiple substrate layers (25; 26), and the strip conductors (30) are formed on both sides of the individual substrate layers (25; 26).

8. The coil assembly (1) as claimed in claim 1, wherein capacitors (8) are disposed on the substrate (2), the capacitors being configured for the reactive power compensation of the coil (50).

9. An inductive energy transmission device (100), comprising at least one coil assembly (1) as claimed in claim 1.

10. A method for manufacturing a coil assembly (1) for inductive energy transmission as claimed in claim 1, having the following method steps of:
providing the electrically non-conductive substrate (2) which has the first side (10) and the second side (11); and
forming the plurality of strip conductors (30) on the first side (10) and on the second side (11) of the substrate (2) for forming the coil (50) for inductive energy transmission.

11. The coil assembly (1) as claimed in claim 1, wherein one of the substrate segments (25) comprises a strip conductor section (31) which is configured for the variable interconnection of the strip conductors (30).

12. The coil assembly (1) as claimed in claim 11, wherein the strip conductor section (31) comprises active switches (35) for adjusting a number of windings and/or a winding cross-section of the coil (50), in order to allow for a variable interconnection.
